(19) United States
(12) Patent Application Publication
(10) Pub. No.: US 2017/0345037 A1
(43) Pub. Date: Nov. 30, 2017

(54) METHODS FOR DISCOUNT PURCHASES

(71) Applicant: Christopher Seaver, Ft. Lauderdale, FL (US)

(72) Inventor: Christopher Seaver, Ft. Lauderdale, FL (US)

(21) Appl. No.: 15/167,821

(22) Filed: May 27, 2016

(51) Int. Cl. G06Q 30/02; G06Q 20/12; G06Q 30/06

(52) U.S. Cl. CPC G06Q 30/0213; G06Q 30/0635; G06Q 20/127; G06Q 30/0257

(57) ABSTRACT

A method for providing-discount-purchases, with the method including the steps of producing one or more advertising-material(s) related to primary-goods-for-purchase, presenting the advertising-material(s) to a subscriber, providing an initial-purchase-price to the subscriber for the primary-goods-for-purchase, and providing future-purchase-discounts to the subscriber based on a subscription for buying the primary-goods-for-purchase. Additionally a method for receiving-discount-purchases may include the steps of accepting one or more advertising-material(s) related to primary-goods-for-purchase from a retailer; agreeing to an initial-purchase-price with the retailer for the primary-goods-for-purchase via a written contract accessible via internet; and receiving future-purchase-discounts from the retailer based on a subscription for buying the primary-goods-for-purchase.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of retail sales and more specifically relates to methods for discount purchases related to subscription contracts.

### 2. Description of Related Art

There are many ways for a consumer to purchase goods in today's modern market system. Generally, two options are most common: a consumer may physically enter a ‘brick-and-mortar’ retail establishment, or may purchase goods online through an online retailer by selecting and paying for (an) item(s) via the internet. However, limitations exist with the modern market system. First, preferences of styles and appearances may change much faster than the standard supply chain available to a brick-and-mortar retail establishment. Second, a consumer must expend much time and energy researching for the most modern and stylish goods to purchase.

One common good that is subject to quickly changing preferences is the cellular (cell or mobile) phone market. It is not uncommon for a particular cell phone model to quickly become obsolete. Additionally, styles and preferences of cell phone accessories are quickly changing. One particular cell phone accessory that many, if not all, cell phone users commonly purchase are cell phone protective covers. However, often times the most modern style of cell phone cover can be expensive. Therefore it is desired to provide a convenient and easily accessible way for a consumer to purchase the most modern style of cell phone protective cover at a minimal price. A suitable solution is desirable.

Several attempts have been made to solve the above-mentioned problems such as those found in U.S. Pub. Nos. 2003/0220839 to Nguyen, and 2013/0132111 to Morgan; and U.S. Pat No. 8,554,673 to McRae et al., U.S. Pat. No. 8,095,425 to Morrow, and U.S. Pat. No. 7,689,469 to Mesaros. This art is representative of retail sales. However, none of the above inventions and patents, taken either singly or in combination, is seen to describe the invention as claimed.

Preferably, a method for discount purchases should provide a seller with a means for selling and distributing a repeat volume of goods to a purchaser/consumer who receives an initial discounted price to agree to a subscription for repeated purchases and, yet would operate reliably and be manufactured at a modest expense. Thus, a need exists for a reliable method for discount purchases to avoid the above-mentioned problems.

### BRIEF SUMMARY OF THE INVENTION

In view of the foregoing disadvantages inherent in the known retail sales art, the present invention provides a novel method for discount purchases. The general purpose of the present invention, which will be described subsequently in greater detail, is to provide a seller with a means for selling a repeat volume of product to a customer, wherein the customer receives a low introductory price for agreeing to a subscription for repeated purchases from the seller.

A method for providing-discount-purchases is disclosed herein, in a preferred embodiment, the method including the steps of: producing one or more advertising-material(s) related to primary-goods-for-purchase (cellular phone cases for example), presenting the advertising-material(s) to a subscriber (via suitable means such as internet advertising for example), providing an initial-purchase-price to the subscriber for the primary-goods-for-purchase (for example 10 initial phone cases for one cent or the like), and providing future-purchase-discounts to the subscriber based on a subscription for buying the primary-goods-for-purchase (wherein the consumer completes the remainder of the contractual agreement through purchasing an agreed amount of cellular phone cases for example one purchase at regular or discounted rate per month for a twelve month period). Other monetizing means and dollar amounts in relation to goods may be used; further other goods may be used. It should be appreciated that the exemplary means for providing cellular phone cases for sale may be replaced by other goods and this does not in any way limit the scope of the inventive method disclosed herein.

In the preferred embodiment, the method for providing-discount-purchases may further include the steps of: providing the customer with a description of the primary-goods-for-purchase, and providing one or more reminder(s) to the potential-subscriber; the one or more reminders useful for reminding the subscriber. Preferably the reminder(s) should be sent to the customer at a first-predetermined-time-interval. In this way monetization may be maximized.

The preferred method may further include: automatically-billing the customer/subscriber for the primary-goods-for-purchase at a second-predetermined-time-interval and automatically-shipping the primary-goods-for-purchase to the subscriber/customer at the same second-predetermined-time-interval. Additionally, the method may preferably include the step of providing the subscriber with alternative-goods-for-purchase at a price which is unequal to the future-purchase-discounts for the primary-goods-for-purchase. The method of the preferred embodiment also include the step of providing the subscriber with an option to cancel the subscription at any time without penalty, with buy-out or provided the contract subscription has been satisfied. In this way the consumer can complete his/her contractual obligations early. It is at the discretion of the provider if a subsequent subscription is made available such that the consumer can be a return purchaser.

In the preferred embodiment, first-predetermined-time-interval and the second-predetermined-time-interval are equal in duration and the primary-goods-for-purchase comprises cell-phone-protective cases as previously mentioned. Other goods may be provided by the provider.

Also disclosed is a method for receiving-discount-purchases, the preferred method including the steps of: accepting one or more advertising-material(s) related to primary-goods-for-purchase from a retailer, agreeing to an initial-purchase-price with the retailer for the primary-goods-for-purchase via a written contract accessible via internet (or other), and receiving future-purchase-discounts from the retailer based on the subscription for buying the primary-goods-for-purchase.

Preferably, the method for receiving-discount-purchases additionally includes the steps of: receiving a description of the primary-goods-for-purchase from the retailer, receiving one or more reminder(s) from the retailer (useful for reminding the subscriber of the subscription at a first-predetermined-time-interval), automatically-paying the retailer for the primary-goods-for-purchase at a second-predetermined-time-interval, and automatically-receiving and/or accepting the primary-goods-for-purchase from the retailer. The provider of goods may include in the contractual agreement for example that cellular phone cases of the consumer's choosing be automatically delivered each month (or other interval) and if no response is received the cellular phone case of the month be delivered by default.

In the preferred embodiment, the method of receiving-discount-purchases additionally includes the steps of selecting alternative-goods-for-purchase at a price which is unequal to the future-purchase-discounts for the primary-goods-for-purchase (regular price or discounted price), and cancelling the subscription at any time without penalty once the written contract is fulfilled.

The first-predetermined-time-interval and the second-predetermined-time-interval may be equal in duration and the primary-goods-for-purchase may comprise cell-phone-protective cases, wherein the cell-phone-protective cases are selected from a variety of the cell-phone-protective cases viewable and selectable online and shipped after order(s) have occurred. Mailings and the like may be used however online delivery is preferred since potential exposure is maximized and advertizing expenses are minimized. Further, the ordering and delivery of goods ordered in this manner are most efficient.

The present invention holds significant improvements and serves as a method for discount purchases and subsequent monetization. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, methods for discount purchases, operative according to the teachings of the present invention.

FIG. 1A shows a perspective view illustrating a cell-phone, and a cell-phone-protective case such as may be offered for monetization according to an embodiment of the present invention.

FIG. 1B shows a perspective view illustrating the cell-phone of FIG. 1A with the attached cell-phone-protective case of FIG. 1A according to an embodiment of the present invention. Various decorative cell-phone-protective cases may be ordered according to consumer preference.

FIG. 2 shows a flowchart illustrating a method for discount purchases as related to a retailer (provider of goods for purchase) according to an embodiment of the present invention

FIG. 3 shows a flowchart illustrating the method for discount purchases as related to a subscriber according to an embodiment of the present invention.

FIG. 4 shows a flowchart illustrating the method for discount purchases as related to both the retailer and the subscriber according to an embodiment of the present invention of FIGS. 2-3.

The various embodiments of the present invention will hereinafter be described in conjunction with the appended drawings, wherein like designations denote like elements.

### DETAILED DESCRIPTION

As discussed above, embodiments of the present invention relate to retail sales and more particularly to a method for discount purchases as used to improve the long-terms sales of a class of goods by a retailer and reduce prices for a subscriber related to those same goods.

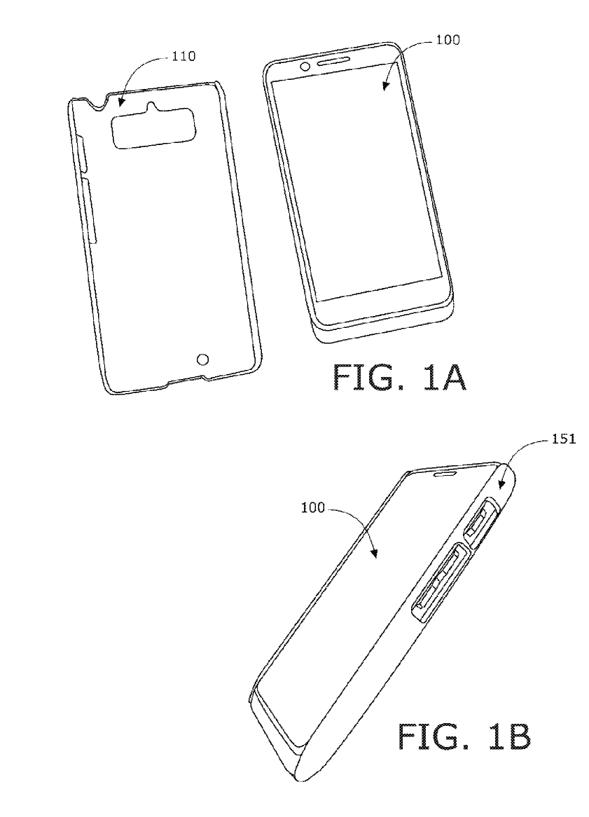

Referring to the drawings by numerals of reference there is shown in FIG. 1A and FIG. 1B, a cellular/mobile telephone and an accompanying protective cover/case. Other goods may be provided however the preferred goods comprise decorative cellular phone cases.

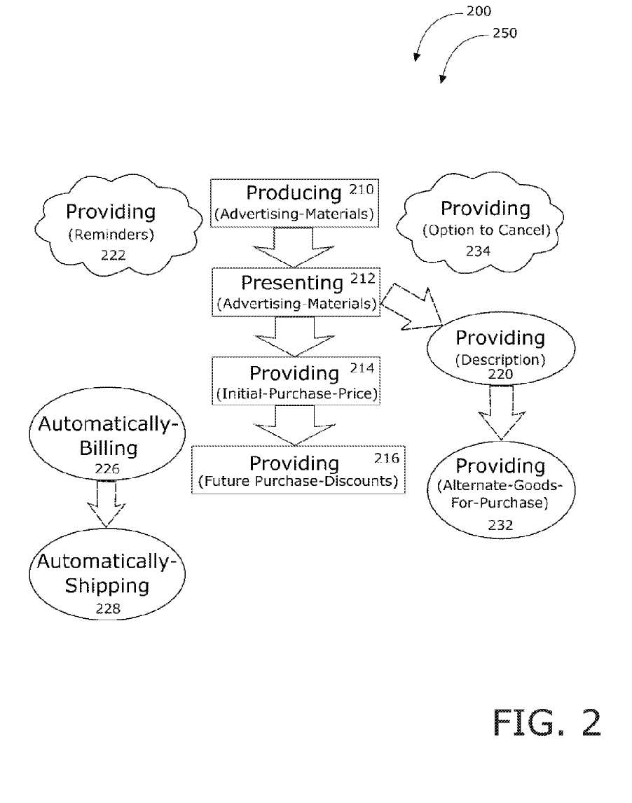

Referring now to FIG. 2, a method for providing-discount-purchases 200 (relating now to the goods shown in FIG. 1A) may comprise the steps of producing one or more advertising-material(s) 210 related to primary-goods-for-purchase, presenting advertising-material(s) 212 to a subscriber, providing an initial-purchase-price 214 to the subscriber for the primary-goods-for-purchase, and providing future-purchase-discounts 216 to the subscriber based on a subscription for buying the primary-goods-for-purchase. In this way the consumer is encouraged to make a contractual agreement with the provider to recognize short term benefit of consumer goods (such as for example ten cellular phone cases may be offered for a penny to be received upon purchase in exchange for agreement to purchase other cellular phone cases at agreed intervals at agreed pricing).

Embodiments of the method for providing-discount-purchases 200 may further comprise the step of providing the customer with a description (and pictures) of the primary-goods-for-purchase 220 and may comprise the step of providing one or more reminder(s) 222 to the potential-subscriber useful for reminding the subscriber of the subscription at a first-predetermined-time-interval.

Additionally versions of the method for providing-discount-purchases 200 may comprise the step of automatically-billing 226 the purchase of primary-goods-for-purchase to the subscriber at a second-predetermined-time-interval and automatically-shipping 228 the primary-goods-for-purchase to the subscriber at the second-predetermined-time-interval.

The method for providing-discount-purchases 200 may additionally comprise the steps of providing the subscriber with alternative-goods-for-purchase 232 at a price which is unequal (greater than) to the future-purchase-discounts for the primary-goods-for-purchase, and the step of providing the subscriber with an option to cancel 234 the subscription at any time, without penalty, with a buy-out option.

The method for providing-discount-purchases may include the first-predetermined-time-interval and the second-predetermined-time-interval which are preferably equal in duration. Alternatively, the first-predetermined-time-interval and the second-predetermined-time-interval may be non-equal in duration. The method for providing-discount-purchases may include primary-goods-for-purchase comprised of cell-phone-protective cases, however, the method for providing-discount-purchases may include other goods depending upon the goods desired to be sold.

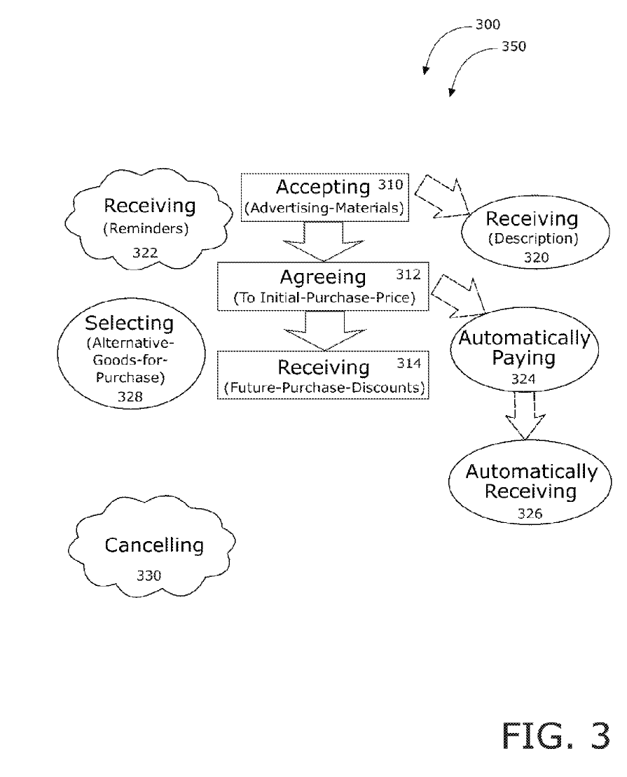

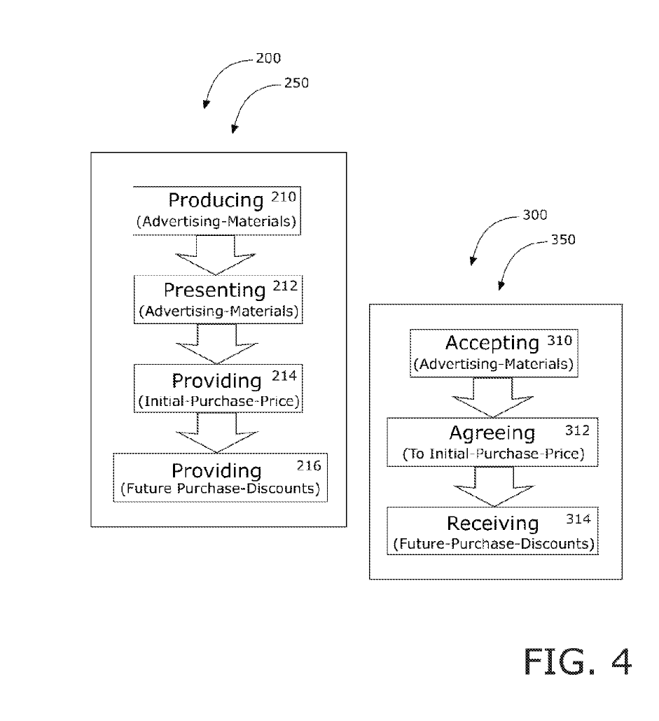

Referring now to FIGS. 3-4, a method for receiving-discount-purchases 300 may comprise the steps of: accepting one or more advertising-material(s) 310 related to primary-goods-for-purchase from a retailer; agreeing to an initial-purchase-price 312 with the retailer for the primary-goods-for-purchase via a written contract accessible via internet; and receiving future-purchase-discounts 314 from the retailer based on a subscription for buying the primary-goods-for-purchase.

The method for receiving-discount-purchases may further comprise the steps of receiving a description of the primary-goods-for-purchase 320 from the retailer (via emails/texts or the like), and the step of receiving one or more reminder(s) 322 from the retailer (useful for reminding the subscriber of the subscription at a first-predetermined-time-interval). Additional steps may include the step of automatically-paying 324 the retailer for the primary-goods-for-purchase at a second-predetermined-time-interval, and the step of automatically-receiving 326 the primary-goods-for-purchase from the retailer.

The method for providing-discount-purchases may further comprise the steps of selecting alternative-goods-for-purchase 328 at a price which is unequal to the future-purchase-discounts for said primary-goods-for-purchase, and the step cancelling 330 the subscription at any time without penalty once the written contract is fulfilled.

In the method for receiving-discount-purchases 300, the first-predetermined-time-interval and the second-predetermined-time-interval may be equal in duration, or the first-predetermined-time-interval and the second-predetermined-time-interval may be non-equal in duration, depending upon preferences and applicability. The method for receiving-discount-purchases 300 may include (without limitation) primary-goods-for-purchase which comprises cell-phone-protective cases, wherein the cell-phone-protective cases are selected from a variety of the cell-phone-protective cases viewable and selectable online and shipped after order(s) have occurred. Other steps may comprise credit checks or the like as per provider's discretion.

It should be noted that the optional/additional steps may not be implemented in all cases. Also, it should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A method for providing-discount-purchases comprising the steps of:
producing one or more advertising-material(s) related to primary-goods-for-purchase;
presenting said advertising-material(s) to a subscriber;
providing an initial-purchase-price to said subscriber for said primary-goods-for-purchase; and
providing future-purchase-discounts to said subscriber based on a subscription for buying said primary-goods-for-purchase.

2. The method for providing-discount-purchases of claim 1 further comprising the step of providing said customer with a description of said primary-goods-for-purchase.

3. The method for providing-discount-purchases of claim 2 further comprising the step of providing one or more reminder(s) to said potential-subscriber useful for reminding said subscriber of said subscription at a first-predetermined-time-interval.

3. The method for providing-discount-purchases of claim 2 further comprising the step of automatically-billing said primary-goods-for-purchase to said subscriber at a second-predetermined-time-interval.

4. The method for providing-discount-purchases of claim 3 further comprising the step of automatically-shipping said primary-goods-for-purchase to said subscriber at said second-predetermined-time-interval.

5. The method for providing-discount-purchases of claim 1 further comprising the step of providing said subscriber with alternative-goods-for-purchase at a price which is unequal to said future-purchase-discounts for said primary-goods-for-purchase.

6. The method for providing-discount-purchases of claim 1 further comprising the step of providing said subscriber with an option to cancel said subscription at any time without penalty with a buy-out.

7. The method for providing-discount-purchases of claim 1 wherein said first-predetermined-time-interval and said second-predetermined-time-interval are equal in duration.

8. The method for providing-discount-purchases of claim 1 wherein said first-predetermined-time-interval and said second-predetermined-time-interval are non-equal in duration.

9. The method for providing-discount-purchases of claim 1 wherein said primary-goods-for-purchase comprises cell-phone-protective cases.

10. A method for receiving-discount-purchases comprising the steps of:
accepting one or more advertising-material(s) related to primary-goods-for-purchase from a retailer;
agreeing to an initial-purchase-price with said retailer for said primary-goods-for-purchase via a written contract accessible via internet; and
receiving future-purchase-discounts from said retailer based on a subscription for buying said primary-goods-for-purchase.

11. The method for receiving-discount-purchases of claim 10 further comprising the step of receiving a description of said primary-goods-for-purchase from said retailer.

12. The method for receiving -discount-purchases of claim 11 further comprising the step of receiving one or more reminder(s) from said retailer, useful for reminding said subscriber of said subscription at a first-predetermined-time-interval.

13. The method for receiving-discount-purchases of claim 11 further comprising the step of automatically-paying said retailer for said primary-goods-for-purchase at a second-predetermined-time-interval.

14. The method for receiving-discount-purchases of claim 13 further comprising the step of automatically-receiving said primary-goods-for-purchase from said retailer.

15. The method for receiving -discount-purchases of claim 10 wherein said further comprising the step of selecting alternative-goods-for-purchase at a price which is unequal to said future-purchase-discounts for said primary-goods-for-purchase.

16. The method for receiving-discount-purchases of claim 10 further comprising the step cancelling said subscription at any time without penalty once said written contract is fulfilled.

17. The method for receiving discount-purchases of claim 10 wherein said first-predetermined-time-interval and said second-predetermined-time-interval are equal in duration.

18. The method for receiving-discount-purchases of claim 10 wherein said first-predetermined-time-interval and said second-predetermined-time-interval are non-equal in duration.

19. The method for receiving-discount-purchases of claim 1 wherein said primary-goods-for-purchase comprises cell-phone-protective cases, wherein said cell-phone-protective cases are selected from a variety of said cell-phone-protective cases viewable and selectable online and shipped after order(s) have occurred.

20. A method for providing-discount-purchases comprising the steps of:
producing one or more advertising-material(s) related to primary-goods-for-purchase;
presenting said advertising-material(s) to a subscriber;
providing an initial-purchase-price to said subscriber for said primary-goods-for-purchase;
providing future-purchase-discounts to said subscriber based on a subscription for buying said primary-goods-for-purchase;
providing said customer with a description of said primary-goods-for-purchase;
providing one or more reminder(s) to said potential-subscriber useful for reminding said subscriber of said subscription at a first-predetermined-time-interval;
automatically-billing said primary-goods-for-purchase to said subscriber at a second-predetermined-time-interval;
automatically-shipping said primary-goods-for-purchase to said subscriber at said second-predetermined-time-interval;
providing said subscriber with alternative-goods-for-purchase at a price which is unequal to said future-purchase-discounts for said primary-goods-for-purchase; and
providing said subscriber with an option to cancel said subscription at any time without penalty with a buy-out;
wherein said first-predetermined-time-interval and said second-predetermined-time-interval are equal in duration; and
wherein said primary-goods-for-purchase comprises cell-phone-protective cases.
